(19) United States
(12) Patent Application Publication
(10) Pub. No.: US 2026/0368108 A1
(43) Pub. Date: Nov. 19, 2026

(54) XSPI PSRAM READ-BURST COMBINATION TO IMPROVE PSRAM BANDWIDTH

(71) Applicant: Ambiq Micro, Inc., Austin, TX (US)

(72) Inventors: Mark Guzzi, Austin, TX (US); Teck Chew, Austin, TX (US); Jason Xu, Austin, TX (US)

(21) Appl. No.: 19/679,224

(22) Filed: May 15, 2026

Related U.S. Application Data
(60) Provisional application No. 63/807,100, filed on May 16, 2025.

(51) Int. Cl. G06F 13/16; G06F 13/42

(52) U.S. Cl. CPC G06F 13/1621; G06F 13/1642; G06F 13/4282

(57) ABSTRACT

A memory system is provided. The memory system includes a pseudo-static random access memory (PSRAM), an interface, and a memory controller. The memory controller is coupled to the PSRAM via the interface. The memory controller is configured to receive access requests to the PSRAM and combine at least two of the access requests to send a single combined access request to the PSRAM.

### CROSS-REFERENCE TO RELATED APPLICATIONS

This application claims the benefit of and priority to U.S. Provisional Application No. 63/807,100, filed May 16, 2025, which is hereby incorporated by reference herein in its entirety.

### TECHNICAL FIELD

The present invention relates generally to random access memory (RAM). More specifically, a system including a pseudo-static RAM (PSRAM) accessible via a combined read-burst is disclosed.

### BACKGROUND

In recent years, due to the growth of portable electronics, there has been a push to increase the compute power provided by microcontrollers (or “MCU”), microprocessors, application processors, digital signal processors (DSPs), neural processing units (NPUs), and other circuits used in portable electronic appliances. While compute power can be increased with the addition of these processing units, increasing memory bandwidth to feed this computation has been lagging. High-speed memory interfaces, such as LPDDR4x and LPDDR5x can provide higher memory bandwidth, but at substantial power penalty that is not feasible in the MCU space.

Instead, the MCU ecosystem has relied upon Pseudo Static RAM (PSRAM) for expanding the memory capacity beyond the traditional on-chip static random access memory (SRAM). PSRAM is a type of memory that combines features of dynamic RAM (DRAM) and static RAM (SRAM). A PSRAM device is a dynamic RAM with an internal refresh circuit, allowing it to behave more like SRAM in terms of external access and interface. PSRAM offers advantages like higher density and smaller chip size compared to SRAM. Processors access PSRAM through protocols such as the serial peripheral interface (SPI) protocol. SPI has been replaced with XSPI (eXpanded Serial Peripheral Interface), which allows higher data transfer rates and improved efficiency.

However, the read performance to a XSPI/ PSRAM by an embedded CPU is typically limited by the size of the burst request. For example, such a request is limited to a 32-byte cache-line fill or prefetch. Given the overhead of accessing the PSRAM device, this limits the read bandwidth to approximately 160MB/sec for 125Mhz Hex DDR, or only 32% of the potential bandwidth on the interface.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a memory system is provided. The memory system includes a pseudo-static random access memory (PSRAM), an interface, and a memory controller coupled to the PSRAM via the interface. The memory controller is configured to receive access requests to the PSRAM and combine at least two of the access requests to send a single combined access request to the PSRAM.

According to certain aspects of the present disclosure, a method for accessing a memory system is provided. The method includes receiving, by a memory controller, a first access request to a pseudo-static random access memory (PSRAM), the memory controller coupled to the PSRAM via an interface. The method further includes combining, by the memory controller, the first access request with a second access request to obtain a single combined access request. The method further includes sending, by the memory controller to the PSRAM, the single combined access request such that the PSRAM performs memory activities defined in the single combined access request.

### BRIEF DESCRIPTION OF THE DRAWINGS

The disclosure will be better understood from the following description of exemplary embodiments together with reference to the accompanying drawings, in which:

FIG. 1 is a diagram of a system on a chip in an energy efficient device requiring near threshold voltages for various components;

FIG. 2 is a block diagram of the example system on a chip in FIG. 1;

FIG. 3 is an architecture for a known process for accessing a PSRAM;

FIG. 4 is an example architecture for burst access of a PSRAM by a memory controller on the system on a chip of FIG. 1; and

FIG. 5 is a flow diagram illustrating a process for accessing a memory, according to certain implementations of the present disclosure; and

FIG. 6A is an architecture for a known process for writing to a PSRAM; and

FIG. 6B is an example architecture for burst writing to a PSRAM by the memory controller on the system on a chip of FIG. 1.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements, and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

As described above, the overhead of accessing a pseudo static random access memory (PSRAM) can limit the read bandwidth on the interface between the PSRAM and the communicating controller. This bandwidth limitation results in an underutilization of the interface. The present disclosure provides systems and methods for improving bandwidth on the interface. In some implementations, the present disclosure is directed toward a process of combining sequential read burst requests to a single PSRAM transaction to a PSRAM. The combination of sequential read burst requests improves the bandwidth of PSRAM accesses significantly.

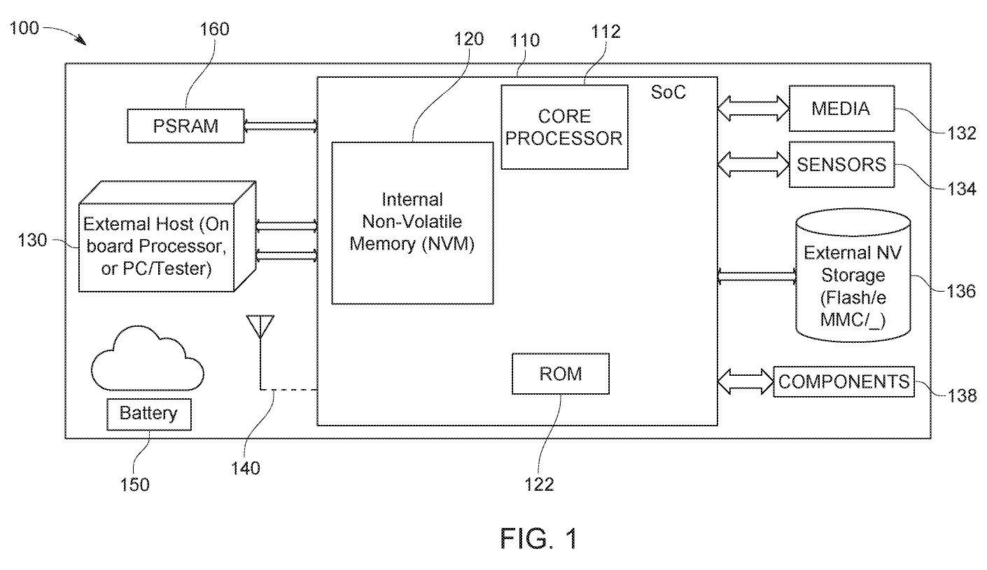

FIG. 1 shows a block diagram of a device 100 with a low power microcontroller system, according to certain aspects of the present disclosure. The low power microcontroller system can be implemented as a system on a chip 110 as represented in FIG. 1. In some implementations, the low power microcontroller system is implemented as multiple discrete systems or components on a common board. The system on a chip 110 includes a core processor 112 and non-volatile memory 120. The core processor 112 includes at least one microcontroller (MCU), central processing unit (CPU), digital signal processor (DSP), neural processing unit (NPU), graphics processing unit (GPU), or any combination thereof. The non-volatile memory 120 can be a magneto-resistive RAM (MRAM). The system on a chip 110 includes other memories such as a read only memory (ROM) 122, volatile memories like static random access memory (SRAM), and so on. In some implementations, the ROM 122 can be a secure boot ROM. In some implementations, the system on a chip 110 is installed in the device 100 and the core processor 112 executes applications generally stored in the non-volatile memory 120 to operate the device 100 to perform different functions.

The device 100 may include an external host processor 130 that controls the functions of the system on a chip 110. The external host processor 130 may be connected via wired interfaces such as Universal Asynchronous Receiver Transmitter (UART), Serial Parallel Interface (SPI), or inter-integrated circuit (I2C) interfaces. The system on a chip 110 controls and accesses a set of components on the device 100 that may include media devices 132 such as a display or an audio output, sensors 134, a non-volatile (NV) memory device 136 such as Multi-bit SPI (MSPI) or eXtended SPI (XSPI) Flash or embedded MultiMediaCard (eMMC), or other components 138. In some implementations, the NV memory device 136 serves as an alternate storage device for storing a recovery image. The host processor 130 can be coupled to a wireless interface 140 such as Bluetooth or WiFi that allows communication with external components to the device 100. In some implementations, a battery 150 provides power to the components of the device 100 including the system on a chip 110. The device 100 also includes a PSRAM 160 that may be accessed by the host processor 130 through a memory controller according to the example routine.

Although not all of the electronic components illustrated in FIG. 1 may be operable in the sub-threshold or near-threshold domains in any particular embodiment, some, at least, may be advantageously adapted to do so, with concomitant reductions in system power dissipation.

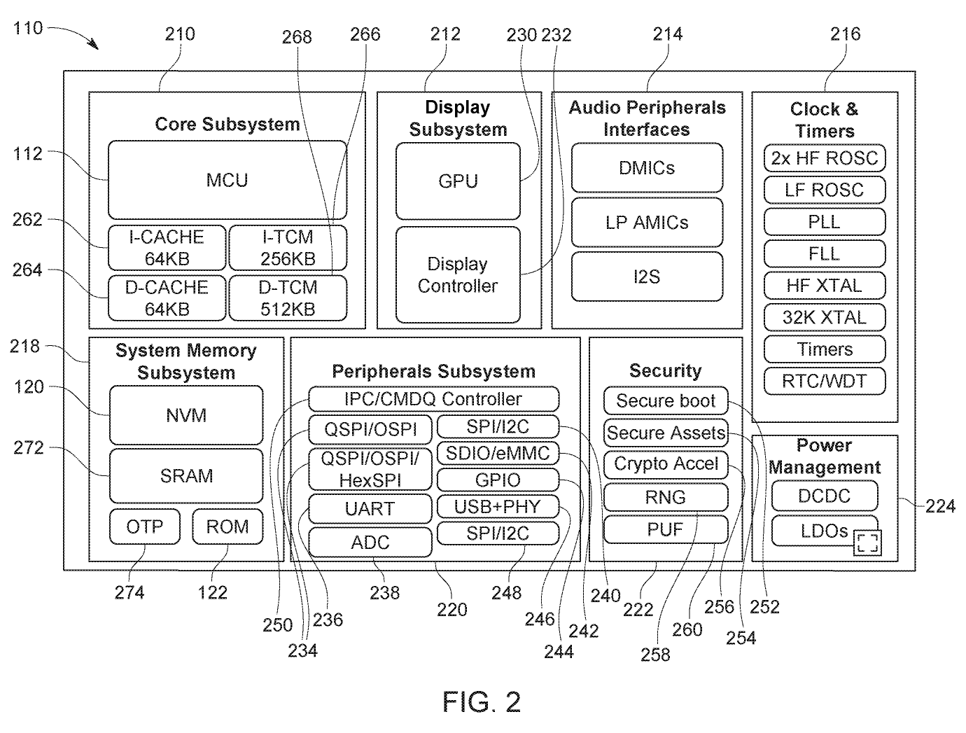

FIG. 2 shows a block diagram of the system on a chip 110 in FIG. 1, according to certain aspects of the present disclosure. The system on a chip 110 includes a core subsystem 210, a display subsystem 212, an audio peripherals interface subsystem 214, a clock and timers subsystem 216, a system memory subsystem 218, a peripheral subsystem 220, a security subsystem 222, and/or a power management subsystem 224. In some implementations, one or more of the subsystems in FIG. 2 are not required. For example, in some implementations, the display subsystem 212, the audio peripherals interface subsystem 214, and the security subsystem 222 can be omitted or provided outside the system on a chip 110. For example, one or more of these subsystems can be provided in the host processor 130. In some implementations, functions associated with one or more of these subsystems can be distributed between the host processor 130 and the system on a chip 110.

The display subsystem 212 includes a graphics processing unit (GPU) 230 and a display controller 232 to drive displays on the device 100. In some implementations, the GPU 230 is a 2.5D GPU supporting vector acceleration and the display controller 232 is an LCD controller. In some implementations, the display controller 232 supports one or more interfaces including Octal SPI (OSPI), Memory in Pixel (MiP) display interface, and/or MIPI display serial interface (DSI).

The audio peripherals interface subsystem 214 includes different audio peripheral interfaces for driving audio components on the device 100. In some implementations, the audio peripheral interfaces include a digital microphone (DMIC) interface supporting pulse density modulation (PDM), a low power always-on audio analog to digital converter (ADC) for supporting an analog microphone (AMIC) input, full-duplex multichannel inter-integrated circuit sound (I2S) interfaces, I2S interfaces supporting Asynchronous Sample Rate Conversion (ASRC), and so on.

The clock and timers subsystem 216 includes timers and clocks for the system on a chip 110. The clock subsystem 216 can include at least one high frequency RC oscillator (HF ROSC), low frequency RC oscillator (LF ROSC), phase locked loop (PLL), frequency locked loop (FLL), high frequency crystal oscillators (HF XTAL), 32 kHz crystal oscillator (32K XTAL), timer, real time clock (RTC), or watchdog timer (WDT).

The peripheral subsystem 220 includes different interfaces such as Quad SPI (QSPI)/OSPI/HexSPI interfaces 234, UART interfaces 236, analog to digital converters 238, SPI/I2C master interfaces 240, SDIO (Secure Digital Input Output)/MMC (Multi-Media card) interfaces 242, a set of general purpose input/output (GPIO) pins 244, a USB interface 246, and a SPI/I2C slave interface 248. The peripheral interfaces are managed by a peripheral controller 250 that manages inter process communication (IPC) and a command queue (CMDQ). The security subsystem 222 includes a secure boot 252, security assets 254, a crypto accelerator 256, a random number generator (RNG) 258 and a physical unclonable function (PUF) 260. The power management subsystem 224 includes power sources such as low drop out (LDO) and DC power regulator supply sources.

The core subsystem 210 includes the core processor 112 that may be any suitable processor, microcontroller, and the like. In this example, the core processor 112 is an ARM Cortex MCU, but any suitable programmable controller or processor may be used. The core subsystem 210 includes an instruction cache 262 and a data cache 264. The core subsystem 210 includes an instruction tightly controlled memory (TCM) 266 and a data TCM 268. The system memory subsystem 218 includes a static random access memory (SRAM) 272, a one-time programmable (OTP) device 274, and the read only memory (ROM) 122. In this example, the SRAM is a synchronous SRAM (SSRAM), and the OTP device 274 is an electronic fuse (eFuse). The OTP device 274 stores data such as trim values that may written during production testing and is read by the core processor 112 for tuning components such as the example adaptable voltage converter. The system memory subsystem 218 also includes the non-volatile memory 120, which is MRAM in this example.

The power management subsystem 224 includes voltage converters and other voltage output circuits. The power management subsystem 224 provides voltage to both digital modules such as the core subsystem 210 and analog modules such as the clocking and timers subsystem 216 and analog to digital converters (“ADC”) in the peripheral subsystem 220, and the like. The power management subsystem 224 includes reference voltage generators and/or reference current generators. The reference voltage generator and reference current generator are each common modules for supplying a stable reference signal to analog modules on the chip 110. The reference voltage generator is sometimes used to derive the output reference current provided by reference current generator.

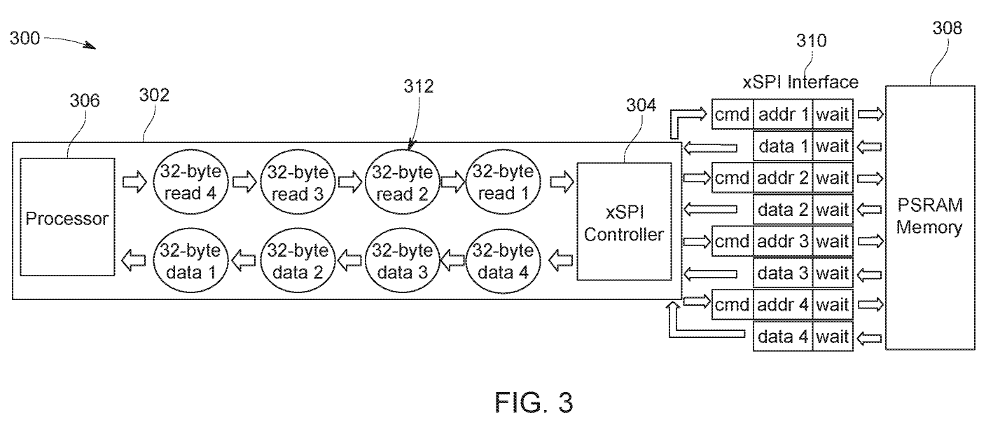

FIG. 3 shows an architecture 300 in the prior art for accessing a PSRAM 308 through an XSPI interface 310. The architecture 300 includes a chip 302 communicating with the PSRAM 308 through the XSPI interface 310. The chip 302 includes a processor 306, a queue 312, and a XSPI controller 304. The XSPI controller 304 facilitates reading data from the PSRAM 308 and/or writing data to the PSRAM 308. The requests in the queue 312 are processed in order. These requests when processed individually can limit the bandwidth of accessing data from the PSRAM 308. As described above, when processing requests in this manner, bandwidth usage can be inefficient due to the multiple CMD/ADDRESS and WAIT cycles to retrieve the data.

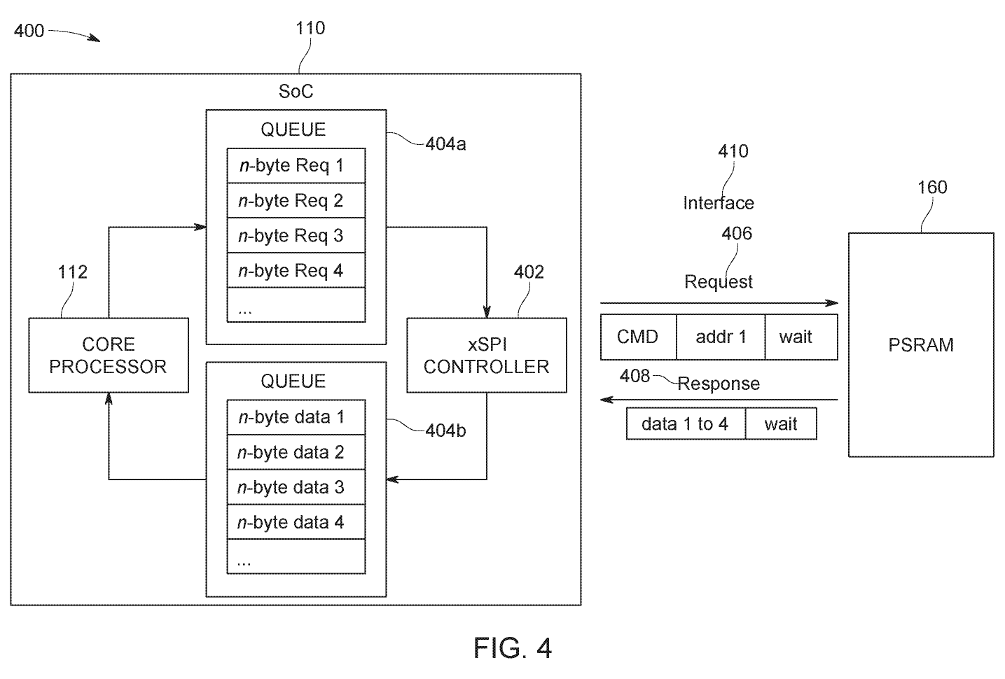

FIG. 4 is an example architecture 400 for burst access of the PSRAM 160 by a XSPI controller 402 on the system on a chip 110. In some implementations, the architecture 400 includes components of the core subsystem 210 and the peripherals subsystem 220. The core processor 112 can run one or more programs or routines that require access to the PSRAM 160. The core processor 112 can place access requests in queue 404a. The access requests can be AXI requests. The XSPI controller 402 can view access requests in the queue 404a to identify access requests that can be combined together. The example process provided in FIG. 4 takes advantage of a processor (i.e., the core processor 112) supporting multiple outstanding accesses and data prefetches. For example, the core processor 112 can run high-demand use-cases that raise multiple small outstanding read transactions in the queue 404a (e.g., an XSPI request queue). For example, while the core processor 112 runs a program, the core processor 112 can push to the queue 404a multiple instruction requests or multiple access requests for the PSRAM 160. These multiple access requests can include n-byte Req 1, n-byte Req 2, …, and so on. The access requests can be read requests or write requests. For example, n-byte Req 1 is a read request, n-byte Req 2 is a write request, n-byte Req 3 is a read request, n-byte Req 4 is a read request, and so on. Multiple read requests can be in sequence in the queue 404a. In some implementations, the requests do not have the same number of bytes. For example, a write request can have a different number of bytes compared to a read request.

In some implementations, an access request operates on 32 bytes (i.e., n=32). For example, the access request can request 32-byte data from the PSRAM 160 or provide 32-byte data to the PSRAM 160. The access request can be prepared by the XSPI controller 402 in different manners depending on the sequence of access requests in the queue 404a. The XSPI controller 402 is configured to form combined access requests using the multiple sequential access requests in the queue of the same type 404a. An example of a combined access request is provided as request 406. An access request can instruct performing of a single action while a combined access request instructs performing multiple actions (i.e., multiple single actions).

In some implementations, request 406 is a single combined access request for a burst read that combines up to four read requests into the single combined access request. For example, the single combined access request can have a first section (i.e., a first set of bits) that indicates CMD bits. The CMD bits can indicate a type of transaction for the single combined access request. For example, the CMD bits can indicate a “read” or can indicate a “write” for reading from the PSRAM 160 or writing to the PSRAM 160, followed by the ADDRESS which indicates the location in the PSRAM for the transactions. After providing the CMD and ADDRESS bits to the PSRAM 160, for a READ, a wait period is observed before the PSRAM responds by providing the DATA requested corresponding to the CMD/ADDRESS. The single combined access request has the same CMD/ADDRESS as the first request being combined.

In some implementations, the CMD bits indicate a read, followed by the PSRAM memory addresses (e.g., start addresses of where to start reading from the PSRAM 160). In some implementations, the CMD bits indicate a write, followed by the PSRAM memory addresses (e.g., start addresses of where to start writing to the PSRAM 160) and write data (e.g., data to be written at the PSRAM memory addresses). After sending the CMD/ADDRESS bits on a READ, the XSPI controller 402 waits for responses from the PSRAM 160. The XSPI controller 402 is configured to scan the queue 404a to identify consecutive access requests that can be combined into a single combined access request, and provide the single combined access request to the PSRAM 160 to perform access requests.

In an example, to implement memory request combining, the XSPI controller 402 scans the queue 404a for multiple sequential read transactions. If there are any sequential access requests relative to the current transaction, the XSPI controller 402 will combine those access requests into a single combined access request. The XSPI controller 402 allows combining at most four 32-byte access requests to obtain a 128-byte combined access request. The combination greatly improves the efficiency of PSRAM data transfer compared to FIG. 3.

In some implementations, the XSPI controller 402 only combines a certain type of memory transaction or memory access request. For example, the XSPI controller 402 only combines read transactions or read requests. The XSPI controller 402 responds to each of the combined memory transactions normally as the data becomes available. That is, response 408 includes combined data. The response 408 is communicated over the interface 410, and the XSPI controller 402 can slice the received response and put into queue 404b. The queue 404b can include data obtained from the PSRAM 160, for example, n-byte data 1, n-byte data 2, n-byte data 3, n-byte data 4, and so on.

In some implementations, any other transaction type in the queue 404a will stop the combination, and the queue entries in the queue 404a will be processed individually until another 32-byte read transaction arrives at the queue head.

In some implementations, the XSPI controller 402 can combine write transactions or write requests. In some implementations, the XSPI controller 402 can combine all sequential write transactions or write requests and all sequential read transactions or read requests. In some implementations, the interface 410 is a fully duplex interface (e.g., an SPI interface) that includes a master interface for transmitting the single combined access request to the PSRAM 160 and a slave interface for receiving data from the PSRAM 160 in response to the combined access request. In some implementations, the interface 410 is a half-duplex interface (e.g., an XSPI interface) where simultaneous read/write is avoided.

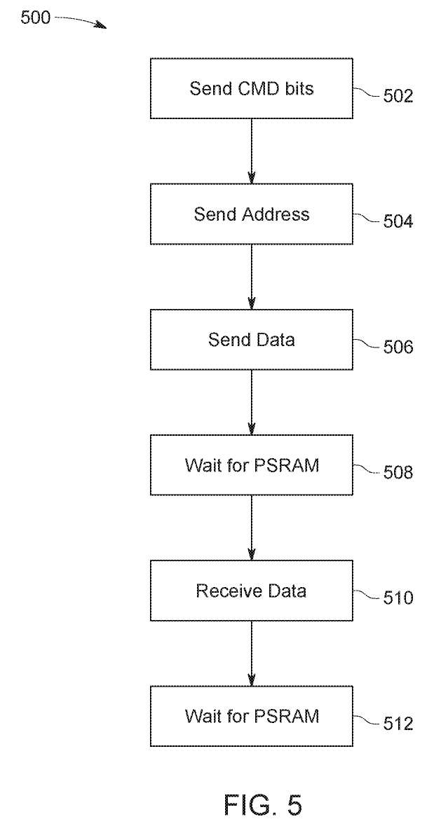

FIG. 5 is a flow diagram illustrating a process 500 for accessing the PSRAM 160, according to some implementations of the present disclosure. The process 500 can be performed by the XSPI controller 402.

At step 502, the XSPI controller 402 sends CMD bits to the PSRAM 160. The CMD bits can indicate a “read” or a “write” transaction is to be performed. In FIG. 5, steps 502, 504, 508, and 510 correspond to steps performed during a read transaction. Steps 502, 504, 506, and 512 correspond to steps performed during a write transaction.

At step 504, the XSPI controller 402 sends address bits to the PSRAM 160. If the CMD bits indicated a “write” transaction, then at step 506, the XSPI controller 402 sends write data to the PSRAM 160.

In the event of a “read” transaction, at step 508, the XSPI controller 402 waits for the PSRAM 160 to configure its internal circuitry to start accessing the data for the specific READ transaction indicated by the CMD /ADDRESS bits of steps 502 and 504. In some implementations, the wait time is about 40 ns (assuming a 125MHz device).

In an example, if there are no combined read requests, the XSPI controller 402 sends a single start address to the PSRAM 160 at step 504 and then waits at step 508 for the PSRAM 160 to respond with data. Then at step 510, once the XSPI controller 402 receives n-bytes of data, then the controller signals a stop by de-asserting a CS signal. The CS signal is a signal that controls start and end on every bus transaction on the interface 410. The XSPI controller 402 can use the CS signal to signal a stop for data reception on the interface 410. The CS signal can be asserted prior to step 502 to indicate that the XSPI controller 402 will start a transaction on the interface 410.

In an example, in an absence of a combined write request, for a single write request, the XSPI controller 402 sends CMD bits indicating a write transaction at step 502; and at steps 504 and 506, sends a start address and the data to be written in the PSRAM 160. In some implementations, once the XSPI controller 402 sends 32-bytes (i.e., the length of data to be written), the XSPI controller 402 signals an end of the write transaction by de-asserting the CS signal during the waiting period of step 512. As discussed above in connection with a single read transaction, the CS signal is merely a control signal and not transmitted on the interface 410. In some implementations, the XSPI controller 402 can respond to an Advanced eXtensible Interface (AXI) write request by returning a BRESP on the AXI write response channel.

Alternatively, the XSPI controller 402 sends a single combined read request to the PSRAM 160. For example, the XSPI controller 402 sends CMD bits indicating a read transaction at step 502; and at step 504, sends a start address (e.g., ADDRESS 1 which includes a first start address). At step 508, the XSPI controller 402 waits for the PSRAM 160 to start sending data. At step 510, the XSPI controller 402 starts receiving data. Once the XSPI controller 402 receives 32-bytes (e.g., when n=32), the XSPI controller 402 responds to the AXI request by returning the 32-bytes of read data to the queue 404b, while still collecting subsequent read data (no STOP). The XSPI controller 402 responds to the subsequent AXI request once the XSPI controller 402 collects 32-bytes from the PSRAM 160. The PSRAM 160 continues streaming data to the XSPI controller 402 until the XSPI controller 402 encounters a non-sequential read access or the XSPI controller 402 has combined four 32-byte sequential reads. That is, the XSPI controller 402 has received four sequential 32-byte read data. When these stop conditions are reached, the XSPI controller 402 de-asserts the CS signal. The XSPI controller 402 uses the CS signal to alert the PSRAM 160 to stop streaming data. For example, in combined read, the CS signal can be used to tell the PSRAM 160 to stop streaming data after 64 bytes, 96 bytes, or 128 bytes.

Alternatively, the XSPI controller 402 sends a single combined write request to the PSRAM 160. For example, the XSPI controller sends CMD bits indicating a write transaction at step 502; and at steps 504 and 506, sends a start address and then sends data to be written to the PSRAM 160. Once the XSPI controller 402 sends 32 bytes, the XSPI controller 402 responds to the AXI request by sending the BRESP signal, while still sending subsequent write data (no STOP) to the PSRAM 160. For every subsequent write data sent, the XSPI controller 402 responds to the subsequent AXI request with the BRESP once it sends 32-bytes. The XSPI controller 402 continues streaming data until the XSPI controller 402 encounters a non-sequential write access or the controller has combined four 32-byte sequential writes. Then the XSPI controller 402 signals a STOP by de-asserting the CS signal at step 512.

The single combined access request has a single CMD that indicates the transaction type. Comparing the request 406 to the single requests in the interface 310, only one CMD is provided to handle multiple read transactions in the single combined access request, instead of each read request being accompanied by a separate CMD. That is, the XSPI controller 402 retains transaction type of a first access request and omits them for access requests subsequent to the first access request.

The XSPI controller 402 receives a combined response from a single combined read access request. As discussed above, the XSPI controller 402 counts a length of bits, as received, and separates the combined response based on a total number of bits received. For example, the first 32 bytes received correspond to a first transaction, the second 32 bytes received correspond to a second transaction, etc.

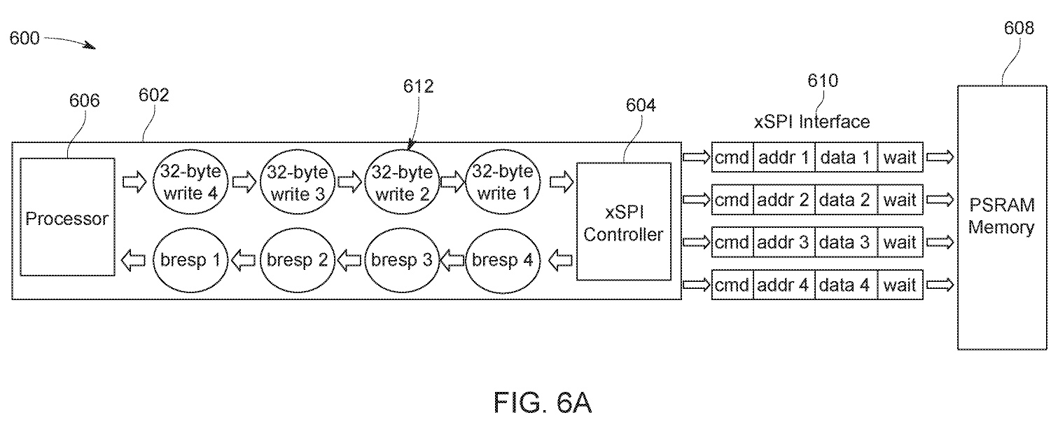

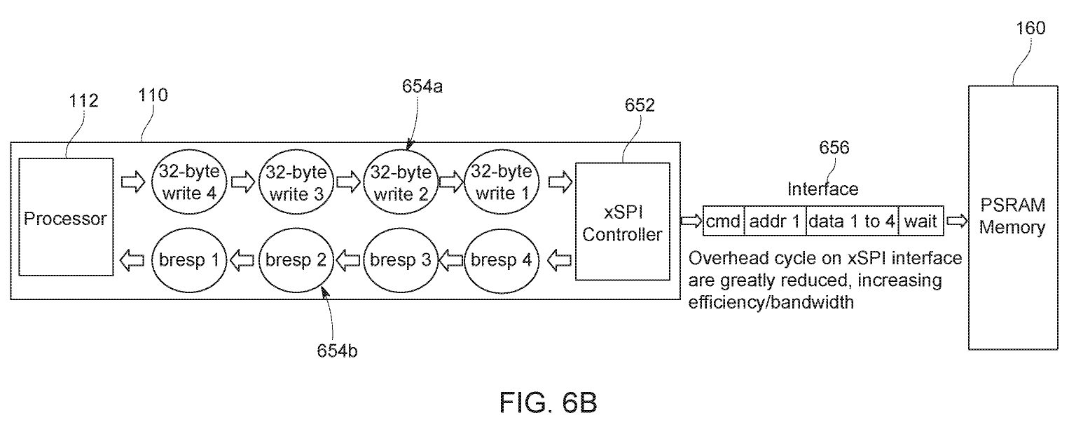

FIGS. 6A and 6B are provided to distinguish between a single write request and a combined write request. In FIG. 6A, an architecture 600 in the prior art is provided for accessing a PSRAM 608 through an XSPI interface 610. A chip 602 communicates with the PSRAM 608 through the XSPI interface 610 managed by an XSPI controller 604. The XSPI controller 604 sends single write requests and provides responses to the processor 606. Similar to FIG. 3, requests are buffered in a queue 612. When writing in this manner, bandwidth usage can be inefficient due to multiple CMD/ADDRESS and WAIT cycles. In contrast, FIG. 6B discloses an extension of the example architecture 400 of FIG. 4 when used for a combined write. A single combined write request is provided over an interface 656 to the PSRAM memory 160. The chip 110 designates queue 654a that includes queued write requests and queue 654b that includes queued BRESP responses. For example, the queue 404a or 654a can buffer AXI requests from the core processor 112 and the queue 404b or 654b can buffer AXI responses to the core processor 112. An XSPI controller 652 (similar to the XSPI controller 402) is shown to combine the write requests and provide the BRESP responses to the processor 112.

Some embodiments of the present disclosure were implemented on a system and measurements were obtained to compare against a known system. In the known system, access occurred in 32 byte bursts with a bandwidth of 160 MB/sec. In the example implemented system, up to four 32-byte requests were combined for a 128-byte PSRAM request, resulting in a 243 MB/sec bandwidth. Some embodiments of the present disclosure provide a new behavior for a memory controller where the memory controller recognizes a set of sequential reads on an AXI bus. The memory controller groups the set of AXI reads together into a single XSPI read to reduce an overhead. The memory controller then takes data from the combined read and splits the data back out to make individual AXI responses. Therefore, some embodiments of the present disclosure are backwards compatible with the XSPI protocol because there are no major changes to the XSPI protocol or PSRAM device. The memory controller provides a more efficient way of managing the XSPI protocol and interface, thus allowing for increased bandwidth.

Although described in the context of communicating on an XSPI interface, some embodiments of the present disclosure can be adapted for other interfaces.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

Each of these embodiments and obvious variations thereof is contemplated as falling within the spirit and scope of the claimed invention, which is set forth in the following claims.

What is claimed is:

1. A memory system comprising:
a pseudo-static random access memory (PSRAM);
an interface; and
a memory controller coupled to the PSRAM via the interface, the memory controller configured to receive access requests to the PSRAM and combine at least two of the access requests to send a single combined access request to the PSRAM.

2. The memory system of claim 1, wherein the interface is an expanded serial peripheral interface (xSPI).

3. The memory system of claim 1, wherein a core processor communicates with the memory controller and provides the access requests.

4. The memory system of claim 1, wherein the memory controller combines up to four of the access requests in the single combined access request.

5. The memory system of claim 1, wherein the memory controller is operable to receive another type of request between the access requests, and wherein the memory controller is operable to send a single access request when another type of request is received.

6. The memory system of claim 1, wherein each of the access requests instructs the PSRAM to perform a single action and the single combined access request instructs the PSRAM to perform multiple actions.

7. The memory system of claim 6, wherein a length of the single combined access request is greater than a length of each of the access requests.

8. The memory system of claim 6, wherein a first access request operates on data that is 32-bytes long and a second access pertaining to the combined access request operates on data that is at least 64-bytes long.

9. The memory system of claim 1, wherein the at least two of the access requests are sequential read access requests, and the memory controller sends the single combined access request to the PSRAM and receives data from the PSRAM.

10. The memory system of claim 9, wherein the interface includes a master interface for sending the single combined access request and a slave interface for receiving the data.

11. The memory system of claim 1, wherein the memory controller combines the at least two of the access requests by retaining a transaction type of a first access request and discarding transaction type of access requests subsequent to the first access request.

12. The memory system of claim 1, further comprising:
a request queue, wherein the memory controller identifies the at least two of the access requests by selecting sequential access requests in the request queue.

13. The memory system of claim 1, wherein the memory controller is further configured to receive a combined access response from the PSRAM and separate the combined access response into a plurality of access responses.

14. The memory system of claim 13, wherein the combined access response is provided as a stream of bytes and the memory controller separates the combined access response into the plurality of access responses by counting and grouping the stream of bytes in an order received.

15. A method for accessing a memory system comprising:
receiving, by a memory controller, a first access request to a pseudo-static random access memory (PSRAM), the memory controller coupled to the PSRAM via an interface;
combining, by the memory controller, the first access request with a second access request to obtain a single combined access request; and
sending, by the memory controller to the PSRAM, the single combined access request such that the PSRAM performs memory activities defined in the single combined access request.

16. The method of claim 15, wherein the interface is an expanded serial peripheral interface.

17. The method of claim 15, wherein the single combined access request further includes a third access request and/or a fourth access request.

18. The method of claim 15, wherein the first access request and the second access request are obtained from a queue coupled to a core processor.

19. The method of claim 18, further comprising:
responding, by the memory controller to the core processor, to a combined response from the PSRAM to the first access request and the second access request.

20. The method of claim 19, wherein the responding to the combined response includes providing first read data corresponding to the first access request and second read data corresponding to the second access request to the core processor.
